(19) United States
(12) Patent Application Publication
(10) Pub. No.: US 2025/0168784 A1
(43) Pub. Date: May 22, 2025

(54) WIRELESS POWER ADJUSTMENT IN A WIRELESS NETWORK

(71) Applicant: Charter Communications Operating, LLC, St. Louis, MO (US)

(72) Inventors: Taren G. McCullough, Plymouth, MN (US); Jason P. Perkins, Parker, CO (US)

(21) Appl. No.: 18/511,280

(22) Filed: Nov. 16, 2023

(51) Int. Cl. H04W 52/42; H04W 52/16; H04W 72/0453

(52) U.S. Cl. CPC H04W 52/42; H04W 52/16; H04W 72/0453

(57) ABSTRACT

Processing hardware receives first power level control information to control operation of a wireless station. The first power level control information includes first control settings to control wireless power output levels of the wireless station for multiple wireless channels. Implementation of the first control settings at the wireless station resulting in different wireless power output levels. The processing hardware produces second power level control information as a replacement to the first power level control information. The second power level control information includes second control settings. Application of the second control settings is operative to substantially equalize wireless power output levels of the wireless station over each of the multiple wireless channels.

### BACKGROUND

The IEEE standard 802.11h and other standards specify different wireless power output levels for different network environments. For example, the standard specifies a first wireless power transmit level (such as 200 milliwatts) for indoor wireless channels; the standard specifies a second wireless power transmit level (such as 1000 milliwatts) for DFS (Dynamic Frequency Selection) channels; the standard specifies a third wireless power transmit level (such as 4000 milliwatts) for outdoor wireless channels.

In general, conventional wireless networks typically include one or more wireless base stations (or wireless access points) that transmit at maximum power levels specified by 802.11 and as allowed by the FCC (Federal Communications Commission) to provide mobile communication devices access to a remote network such as the Internet. Transmitting at highest available levels ensures that respective communication devices are able to receive wireless communications at a desired level of quality.

Access Points (APs) communicate with respective Stations (STAs) on pre-defined channels, or slices of spectrum, approved by the FCC (Federal Communication Commission). Each wireless channel may have a slightly lower or higher power level associated with it based on the hardware components and system design; e.g. Radio, FEM, Filter, antenna, etc. In some cases, certain channels can become over-utilized. Access points operating on the overutilized channel may experience reduced performance due to interference. When an AP and/or cloud algorithm for AP channel management decides that the currently assigned operating channel is not optimal, a change channel is invoked by either the AP and/or cloud to another wireless channel that is deemed to be more optimal.

### BRIEF DESCRIPTION OF EXAMPLES

There are deficiencies associated with conventional techniques of providing wireless connectivity to the communication devices according to conventional techniques. For example, there is no way to know which wireless stations in a respective network environment will be impacted or disconnected when a new wireless channel is selected for communicating in a region of wireless coverage as a substitute to an original selected wireless channel.

As a more specific example, transmitting at different preset wireless output power levels for each of multiple wireless channels results in uncertainty because selection of a second wireless channel as a replacement to a first wireless channel to communicate with a wireless station may result in reduced cell coverage. In other words, wireless transmissions from a wireless station using the second wireless channel (potentially assigned a lower power level) may support a smaller region of wireless coverage than a corresponding region of wireless coverage associated with the first wireless channel (assigned a higher power level). The channel power level of the selected target channel during a channel change is not taken into consideration for channel change algorithms. Thus, the reduction in cell coverage using the second wireless channel as a replacement to the first wireless channel on a respective channel switch over may impact edge-of-cell wireless stations connected to the higher-power channel. More specifically, the first wireless channel may be transmitted at a sufficiently high power to communicate with a communication device whereas communications transmitted over the second wireless channel may not be received by the communication device because they are transmitted at a lower power. This can result in poor throughput or undesirable disconnects.

Examples herein include the observation that wirelessly communicating (from wireless stations such as base stations, wireless access points, mobile communication devices, etc.) at varying wireless transmitter power levels provides an efficient use of a respective wireless spectrum.

In contrast to conventional techniques, to provide a more efficient use of wireless channels, examples herein include producing or adjusting wireless control settings such that each of the wireless control settings for different channels produces a respective substantially same wireless transmit power output level from the wireless station.

For example, communication management resource (such as hardware software) as discussed herein determines wireless power level control settings to provide substantially equal wireless power output from antenna hardware of a wireless station for each of multiple wireless channels. Via the determined wireless power level control settings, the communication management hardware produces wireless power level control information to control the wireless station.

In accordance with further examples as discussed herein, the communication management resource can be configured to configure the wireless station with the newly generated wireless power level control information.

In further examples, the newly generated wireless power level control information is updated wireless power level control information with respect to first wireless power level control information initially associated with the wireless station. The communication management resource can be configured to analyze corresponding wireless output power levels associated with the wireless station transmitting wireless signals via different settings of the first wireless power level control information to determine a particular wireless channel amongst the multiple wireless channels that provides a lowest wireless output power level from the antenna hardware of the wireless station. The communication management resource then selects a first wireless power level control setting for a first wireless channel of the multiple wireless channels. Application of the first wireless power level control setting to the antenna hardware of the wireless station produces a first wireless output power from the antenna hardware. The first wireless output power is substantially equal to the lowest wireless output power level. The communication management resource selects a second wireless power level control setting for a second wireless channel of the multiple wireless channels, application of the second wireless power level control setting to the antenna hardware of the wireless station producing a second wireless output power from the antenna hardware, the second wireless output power being substantially equal to the lowest wireless output power level.

In still further examples, the determined wireless power level control settings indicate settings to apply to corresponding antenna hardware driver circuitry of the wireless station. The corresponding antenna hardware driver circuitry controls transmission of communications from the antenna hardware of the wireless station.

Yet further, the communication management resource can be configured to select a reference wireless power output level. Determination of the wireless power level control settings further may include: deriving the wireless power level control settings based on the reference wireless power output level. Selection of the wireless power level control settings may include: testing different wireless power level control settings for each respective wireless channel of the multiple wireless channels to determine a corresponding wireless power level control setting for the respective wireless channel, application of the corresponding wireless power level control setting producing a wireless power output level of the antenna hardware of the wireless station to be substantially equal to the reference wireless power output level for the respective wireless channel.

As further discussed herein, the produced (new) wireless power level control information may be second wireless power level control information with respect to first wireless power level control information associated with the wireless station. Application of different wireless power level control settings to the wireless station as indicated by the first (original) wireless power level control information results in different wireless power output levels for each of the multiple wireless channels. Application of the power control settings as specified by the second wireless power level control information results in transmission of wireless communications at substantially the same power level for the different wireless channels.

Another example herein includes a communication management resource that receives first power level control information to control operation of a wireless station. The first power level control information includes first control settings to control wireless power output levels of the wireless station for multiple wireless channels. The communication management resource produces second power level control information as a replacement to the first power level control information. The second power level control information can be configured to include second control settings. Application of the second control settings is operable to substantially equalize wireless power output levels of the wireless station over each of the multiple wireless channels.

In a yet further example, the communication management resource as discussed herein can be configured to configure the wireless station with the second power level control information as the replacement to the first power level control information.

As further discussed herein, the second control settings can be configured to indicate different settings to apply to corresponding antenna hardware driver circuitry of the wireless station. The corresponding antenna hardware driver circuitry controls transmission of communications from antenna hardware of the wireless station.

Still further, generation of the second power level control information may include: determining a first wireless output level of the wireless station for a first wireless channel of the multiple wireless channels based on a first setting of the first control settings; and selecting the first wireless output level as a basis (such as reference) in which to control the wireless output of the wireless station for the second control settings.

Examples herein are useful over conventional techniques. For example, as previously discussed, adjusting wireless output levels of a respective wireless station provides a better use of available wireless spectrum in a network environment.

Note that any of the resources as discussed herein can include one or more computerized devices, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes a computer readable storage medium and/or system having instructions stored thereon to facilitate use of a wireless spectrum in a network environment. The instructions, when executed by computer processor hardware, cause the computer processor hardware (such as one or more co-located or disparately processor devices) to: receive first power level control information to control operation of a wireless station, the first power level control information including first control settings to control wireless power output levels of the wireless station for multiple wireless channels; and produce second power level control information as a replacement to the first power level control information, the second power level control information including second control settings, application of the second control settings operable to substantially equalize wireless power output levels of the wireless station over each of the multiple wireless channels.

Another example herein includes a computer readable storage medium and/or system having instructions stored thereon to facilitate use of a wireless spectrum in a network environment. The instructions, when executed by computer processor hardware, cause the computer processor hardware (such as one or more co-located or disparately processor devices) to: determine wireless power level control settings to provide substantially equal wireless power output from antenna hardware of a wireless station for each of multiple wireless channels; and via the wireless power level control settings, produce wireless power level control information to control the wireless station.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of supporting wireless communications in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment and implementation of first power control information and corresponding different regions of wireless coverage provided by a wireless station for different wireless channels as discussed herein.

FIG. 2 is an example graph illustrating different wireless transmit levels of the wireless station associated with the first power control information as discussed herein.

FIG. 3 is an example diagram illustrating a wireless network environment and implementation of first power control information and corresponding different regions of wireless coverage provided by the wireless station for the different wireless channels as discussed herein.

FIG. 4 is an example diagram illustrating implementation of power output control settings associated with the first power level control information as discussed herein.

FIG. 5 is an example diagram illustrating how switchover from a first wireless channel to a second wireless channel using the first power level control information may result in a corresponding lost connection to a respective mobile communication device as discussed herein.

FIG. 6 is an example diagram illustrating a technique of analyzing wireless power output of a respective wireless station implementing the first power level control information to determine a reference wireless power output level of the wireless station amongst multiple different wireless channels as discussed herein.

FIG. 7 is an example diagram illustrating generation of second power level control information providing substantially equal wireless power output for each of multiple wireless channels as discussed herein.

FIG. 8 is an example diagram illustrating implementation of the alternative power control settings to provide communication devices wireless connectivity to a remote network as discussed herein.

FIG. 9 is an example diagram illustrating initial implementation of third power level control information providing substantially unequal wireless power output for each of multiple wireless channels as discussed herein.

FIG. 10 is an example diagram illustrating example computer architecture operable to execute one or more operations according to examples herein.

FIGS. 11 and 12 are example are example diagrams illustrating methods according to examples herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A communication management resource receives first power level control information to control operation of a wireless station. The first power level control information includes first control settings to control first wireless power output levels of the wireless station for each of multiple wireless channels. Each of the first control settings controls the wireless station to transmit communications at a different wireless power output level. Accordingly, implementation of different wireless channels by the wireless station results in corresponding different sizes of wireless coverage supported by the wireless station (such as a wireless access point) when the first control settings are used.

The communication management resource or other suitable entity processes the first control settings to produce second control settings. For example, the processing may include analyzing or measuring power output from the wireless station over the different wireless channels. Based on the processing, the communication management resource produces second power level control information as a replacement to the first power level control information. The second power level control information can be configured to include second control settings derived at least in part from the processing. Application of the second control settings as a replacement to the first control settings results in substantial equalization of wireless power output levels of the wireless station over each of the multiple wireless channels. In such an instance, for the second control settings, a corresponding region of wireless coverage supported by the wireless station for each of the different wireless channels is basically the same.

Thus, to create a uniform experience for a wireless station (such as a customer STA provided access to a remote network through a wireless access point), the power levels of multiple channels across a specific wireless band are reduced to a selected reference value such as a minimum output power value. This ensures that, regardless of what wireless channel is used to support wireless communications from a wireless station, the corresponding region of wireless coverage associated with the wireless station will generally be constant (such as approximately the same size) for each of the different wireless channels and there will be fewer or no dropped communication links due to channel changes. In other words, as discussed herein, the wireless power output for each channel across can be set to a same wireless transmit power output as the selected reference power level. By flattening the channel powers as described herein to the selected reference power level, a more uniform wireless connectivity experience is provided to communication devices, resulting in a reduction in trouble calls when a channel change occurs and STAs (STAtions) are disconnected due to power variances.

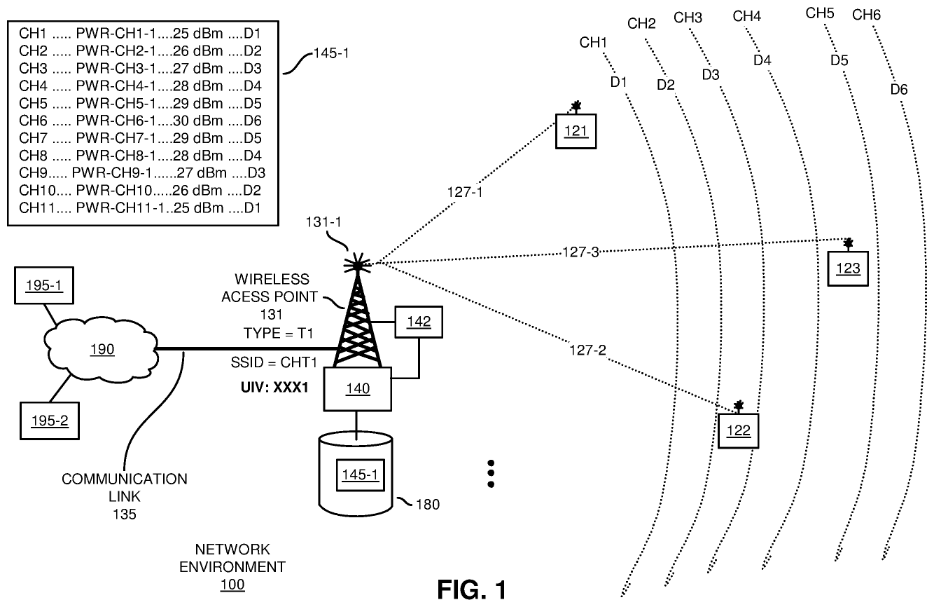

Now, more specifically, FIG. 1 is an example diagram illustrating a wireless network environment and implementation of first power level control information and corresponding different regions of wireless coverage provided by a wireless station for different wireless channels as discussed herein.

As shown, network environment 100 includes communication management resource 140, wireless access point 131 (of type T1), and multiple communication devices including mobile communication device 121, mobile communication device 122, mobile communication device 123, etc.

In this example, the wireless access point 131 supports a respective wireless communication link between itself and each of the mobile communication devices in the network environment 100. For example, via the antenna hardware 131-1, the wireless station 131 is in wireless communication with the mobile communication device 121 over the wireless communication link 127-1; via the antenna hardware 131-1, the wireless station 131 is in wireless communication with the mobile communication device 122 over the wireless communication link 127-2; via the antenna hardware 131-1, the wireless station 131 is in wireless communication with the mobile communication device 123 over the wireless communication link 127-3; and so on.

Via communications over the wireless communication links 127 and through the wireless access point 131, the wireless access point 131 provides each of the mobile communication devices access to the remote network 190.

For example, in a downlink direction, the wireless access point 131 receives communications (such as data packets) from a server resource (195-1, 195-2, etc.) in the network 190 and conveys the data packets over a respective wireless communication link 127-1 to the mobile communication device 121. In an uplink direction, the wireless access point 131 receives wireless communications from the mobile communication device 121 over the wireless communication link 127-1 and conveys those received communications (such as data packets) to an appropriate destination node (such as a server resource 195-1, server resource 195-2, etc.) in the network 190.

Further, in a downlink direction, the wireless access point 131 receives communications (such as data packets) from a resource in the network 190 and conveys the data packets over a respective wireless communication link 127-2 to the mobile communication device 122. In an uplink direction, the wireless access point 131 receives wireless communications from the mobile communication device 122 over the wireless communication link 127-2 and conveys those received communications (such as data packets) to an appropriate destination node in the network 190.

Still further, in a downlink direction, the wireless access point 131 receives communications (such as data packets) from a resource in the network 190 and conveys the data packets over a respective wireless communication link 127-3 to the mobile communication device 123. In an uplink direction, the wireless access point 131 receives wireless communications from the mobile communication device 123 over the wireless communication link 127-3 and conveys those received communications (such as data packets) to an appropriate destination node in the network 190.

As further shown, the communication management resource 140 (such as controller) can be configured with power control information 145-1. The power control information 145-1 includes respective power control settings to apply to the antenna driver circuitry 142 and corresponding antenna hardware 131-1 for each of the different selectable wireless channels. In general, the power control information 145-1 is used as a basis to determine a respective wireless transmit power level in which to operate the antenna hardware 131-1.

The wireless access point 131 can be configured to establish the respective wireless communication links 127 using the different wireless channels such as one or more of the wireless channel #1, wireless channel #2, wireless channel #3, . . . , wireless channel #11. The different power control settings as indicated by the power control information 145-1 specify how to control settings applied to the antenna hardware driver circuitry 142 for each of the different wireless channels. Application of the different power control settings to the antenna driver circuitry 142 controls the respective transmit power output level of the antenna hardware 131-1.

For example, when wireless channel #1 is selected to communicate from the wireless station 131 and corresponding antenna hardware 131-1, in order to transmit wireless signals from the antenna hardware 131-1 at a maximum wireless output level for wireless channel #1, the communication management resource 140 applies control settings PWR-CH1-1 to the antenna hardware driver circuitry 142. In such an instance, the antenna hardware 131-1 transmits wireless signals over a respective wireless communication link to a mobile communication device at a wireless transmit power level of 25 dBm.

When wireless channel #2 is selected to communicate from the wireless station 131 and corresponding antenna hardware 131-1, in order to transmit wireless signals from the antenna hardware 131-1 at a maximum wireless output level for wireless channel #2, the communication management resource 140 applies control settings PWR-CH2-1 to the antenna hardware driver circuitry 142. In such an instance, the antenna hardware 131-1 transmits wireless signals over a respective wireless communication link to a mobile communication device at a wireless transmit power level of 26 dBm.

When wireless channel #3 is selected to communicate from the wireless station 131 and corresponding antenna hardware 131-1, in order to transmit wireless signals from the antenna hardware 131-1 at a maximum wireless output level for wireless channel #3, the communication management resource 140 applies control settings PWR-CH3-1 to the antenna hardware driver circuitry 142. In such an instance, the antenna hardware 131-1 transmits wireless signals over a respective wireless communication link to a mobile communication device at a power level of 27 dBm.

When wireless channel #4 is selected to communicate from the wireless station 131 and corresponding antenna hardware 131-1, in order to transmit wireless signals from the antenna hardware 131-1 at a maximum wireless output level for wireless channel #4, the communication management resource 140 applies control settings PWR-CH4-1 to the antenna hardware driver circuitry 142. In such an instance, the antenna hardware 131-1 transmits wireless signals over a respective wireless communication link to a mobile communication device at a power level of 28 dBm.

When wireless channel #5 is selected to communicate from the wireless station 131 and corresponding antenna hardware 131-1, in order to transmit wireless signals from the antenna hardware 131-1 at a maximum wireless output level for wireless channel #5, the communication management resource 140 applies control settings PWR-CH5-1 to the antenna hardware driver circuitry 142. In such an instance, the antenna hardware 131-1 transmits wireless signals over a respective wireless communication link to a mobile communication device at a power level of 29 dBm.

When wireless channel #6 is selected to communicate from the wireless station 131 and corresponding antenna hardware 131-1, in order to transmit wireless signals from the antenna hardware 131-1 at a maximum wireless output level for wireless channel #6, the communication management resource 140 applies control settings PWR-CH6-1 to the antenna hardware driver circuitry 142. In such an instance, the antenna hardware 131-1 transmits wireless signals over a respective wireless communication link to a mobile communication device at a power level of 30 dBm.

When wireless channel #7 is selected to communicate from the wireless station 131 and corresponding antenna hardware 131-1, in order to transmit wireless signals from the antenna hardware 131-1 at a maximum wireless output level for wireless channel #7, the communication management resource 140 applies control settings PWR-CH7-1 to the antenna hardware driver circuitry 142. In such an instance, the antenna hardware 131-1 transmits wireless signals over a respective wireless communication link to a mobile communication device at a power level of 29 dBm.

When wireless channel #8 is selected to communicate from the wireless station 131 and corresponding antenna hardware 131-1, in order to transmit wireless signals from the antenna hardware 131-1 at a maximum wireless output level for wireless channel #8, the communication management resource 140 applies control settings PWR-CH8-1 to the antenna hardware driver circuitry 142. In such an instance, the antenna hardware 131-1 transmits wireless signals over a respective wireless communication link to a mobile communication device at a power level of 28 dBm.

When wireless channel #9 is selected to communicate from the wireless station 131 and corresponding antenna hardware 131-1, in order to transmit wireless signals from the antenna hardware 131-1 at a maximum wireless output level for wireless channel #9, the communication management resource 140 applies control settings PWR-CH9-1 to the antenna hardware driver circuitry 142. In such an instance, the antenna hardware 131-1 transmits wireless signals over a respective wireless communication link to a mobile communication device at a power level of 27 dBm.

When wireless channel #10 is selected to communicate from the wireless station 131 and corresponding antenna hardware 131-1, in order to transmit wireless signals from the antenna hardware 131-1 at a maximum wireless output level for wireless channel #10, the communication management resource 140 applies control settings PWR-CH10-1 to the antenna hardware driver circuitry 142. In such an instance, the antenna hardware 131-1 transmits wireless signals over a respective wireless communication link to a mobile communication device at a power level of 26 dBm.

When wireless channel #11 is selected to communicate from the wireless station 131 and corresponding antenna hardware 131-1, in order to transmit wireless signals from the antenna hardware 131-1 at a maximum wireless output level for wireless channel #11, the communication management resource 140 applies control settings PWR-CH11-1 to the antenna hardware driver circuitry 142. In such an instance, the antenna hardware 131-1 transmits wireless signals over a respective wireless communication link to a mobile communication device at a power level of 25 dBm.

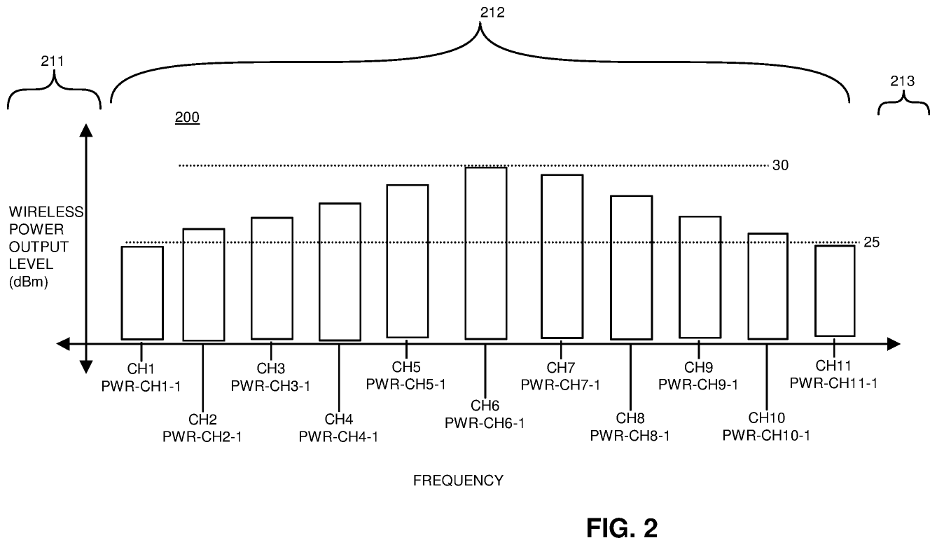

As shown in FIG. 2, the different maximum wireless power output levels associated with the different wireless channels and corresponding power control settings 145-1 are chosen to prevent or reduce interference to side bands with respect to a band in which the wireless channels 1-11 reside. For example, wireless channels #1 and #11 at the sides of the band support wireless output power levels of 25 dBm compared to wireless channel #6 that supports a wireless output power level of 30 dBm.

FIG. 2 is an example graph illustrating different wireless transmit levels of the wireless station associated with the first power level control information as discussed herein.

In this example, as shown in graph 200, each of the wireless channels #1 through #11 resides in a respective frequency band 212. The frequency band 212 can be configured to support any type of communications in accordance with any suitable wireless application protocol.

As previously discussed, the initial or starting power control settings 145-1 are initially chosen to provide a maximum possible wireless power output level for each of the wireless channels. For example, the wireless channel #1 and channel #11 are set to a lower power level than wireless channel #6 in order to reduce interference caused by the wireless transmissions from the antenna hardware 131-1 to the frequency band 211 and frequency band 213. In other words, the magnitude of the wireless power of the levels increase from wireless channel #1 to wireless channel #6; the magnitude of the wireless power output levels decrease from wireless channel #6 to wireless channel #11.

Referring again to FIG. 1, based on different output power levels, note that each of the different wireless channels supports a different sides region of wireless coverage in accordance with the power level associated with the channel.

For example, assume that the communication management resource 140 or other suitable entity selects wireless channel #1 to communicate with one or more mobile communication devices in the network environment 100. In such an instance, the communication management resource 140 applies the power control setting PWR-CH1-1 to the antenna hardware driver circuitry 142. Based on the power control setting PWR-CH1-1 (such as wireless communications transmitted at a power level of 25 dBm), the antenna hardware 131-1 is able to communicate with any communication devices within distance D1 (or range D1) measured from the wireless station (wireless access point 131). In other words, a wireless station (such as any of the mobile communication devices) inside of the region of wireless coverage defined by the distance D1 from the wireless access point 131 is able to receive wireless signals over the wireless channel #1 transmitted from the antenna hardware 131-1. Conversely, a wireless station (such as any of the mobile communication devices) outside of the region wireless coverage defined by the distance D1 from the wireless access point 131 is not able to receive wireless signals over the wireless channel #1 transmitted from the antenna hardware 131-1.

Assume that the communication management resource 140 selects wireless channel #2 to communicate with one or more mobile communication devices in the network environment 100. In such an instance, the communication management resource 140 applies the power control setting PWR-CH2-1 to the antenna hardware driver circuitry 142. Based on the power control setting PWR-CH2-1 (such as wireless communications transmitted at a power level of 26 dBm), the antenna hardware 131-1 is able to communicate with any communication devices within distance D2 measured from the wireless access point 131. In other words, a wireless station inside of the region of wireless coverage defined by the distance D2 from the wireless access point 131 is able to receive wireless signals over the wireless channel #2 transmitted from the antenna hardware 131-1. Conversely, a wireless station outside of the region wireless coverage defined by the distance D2 from the wireless access point 131 is not able to receive wireless signals over the wireless channel #2 transmitted from the antenna hardware 131-1.

Assume that the communication management resource 140 selects wireless channel #3 to communicate with one or more mobile communication devices in the network environment 100. In such an instance, the communication management resource 140 applies the power control setting PWR-CH3-1 to the antenna hardware driver circuitry 142. Based on the power control setting PWR-CH3-1 (such as wireless communications transmitted at a power level of 27 dBm), the antenna hardware 131-1 is able to communicate with any communication devices within distance D3 measured from the wireless station. In other words, a receiver wireless station inside of the region of wireless coverage defined by the distance D3 from the wireless access point 131 is able to receive wireless signals over the wireless channel #3 transmitted from the antenna hardware 131-1. Conversely, a wireless station outside of the region wireless coverage defined by the distance D2 from the wireless access point 131 is not able to receive wireless signals over the wireless channel #3 transmitted from the antenna hardware 131-1.

Assume that the communication management resource 140 selects wireless channel #6 to communicate with one or more mobile communication devices in the network environment 100. In such an instance, the communication management resource 140 applies the power control setting PWR-CH6-1 to the antenna hardware driver circuitry 142. Based on the power control setting PWR-CH6-1 (such as wireless communications transmitted at a power level of 30 dBm or around 1 watt), the antenna hardware 131-1 is able to communicate with any communication devices within distance D6 measured from the wireless station. In other words, a receiver wireless station inside of the region of wireless coverage defined by the distance D6 from the wireless access point 131 is able to receive wireless signals over the wireless channel #6 transmitted from the antenna hardware 131-1. Conversely, a wireless station outside of the region wireless coverage defined by the distance D6 from the wireless access point 131 is not able to receive wireless signals over the wireless channel #6 transmitted from the antenna hardware 131-1.

Thus, depending on which of the multiple wireless channels is selected to communicate with the communication devices in the network environment 100, the wireless access point 131 (also known as a wireless station) provides different regions of wireless coverage.

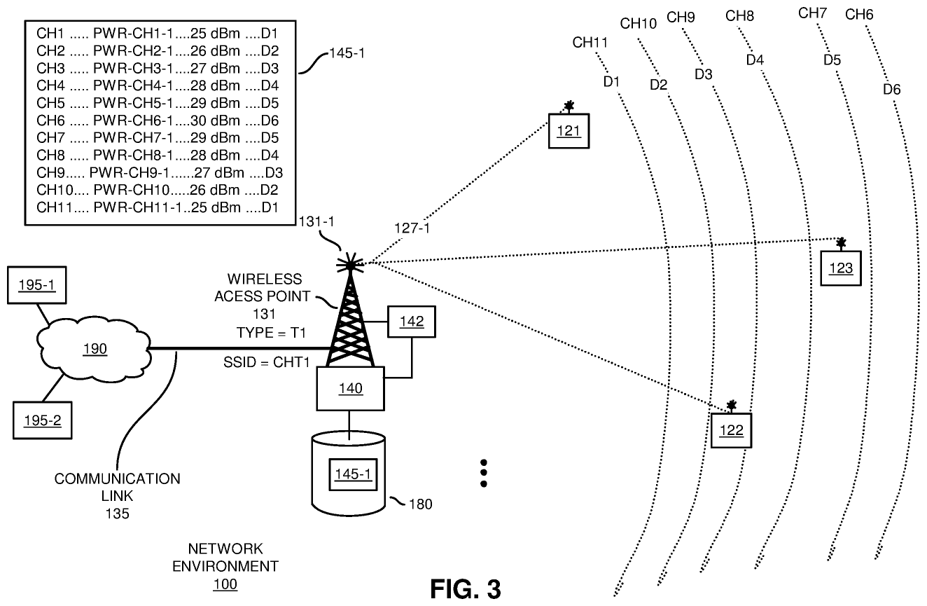

FIG. 3 is an example diagram illustrating a wireless network environment and implementation of first power level control information and corresponding different regions of wireless coverage provided by the wireless station (wireless access point) for the different wireless channels as discussed herein.

Assume that the communication management resource 140 selects wireless channel #11 to communicate with one or more mobile communication devices in the network environment 100. In such an instance, the communication management resource 140 applies the power control setting PWR-CH11-1 to the antenna hardware driver circuitry 142. Based on the power control setting PWR-CH11-1 (such as wireless communications transmitted at a power level of 25 dBm), the antenna hardware 131-1 is able to communicate with any communication devices within distance D1 measured from the wireless station. In other words, a wireless station inside of the region of wireless coverage defined by the distance D1 from the wireless access point 131 is able to receive wireless signals over the wireless channel #11 transmitted from the antenna hardware 131-1. Conversely, a wireless station outside of the region wireless coverage defined by the distance D1 from the wireless access point 131 is not able to receive wireless signals over the wireless channel #11 transmitted from the antenna hardware 131-1.

Assume that the communication management resource 140 selects wireless channel #10 to communicate with one or more mobile communication devices in the network environment 100. In such an instance, the communication management resource 140 applies the power control setting PWR-CH10-1 to the antenna hardware driver circuitry 142. Based on the power control setting PWR-CH10-1 (such as wireless communications transmitted at a power level of 26 dBm), the antenna hardware 131-1 is able to communicate with any communication devices within distance D2 measured from the wireless station. In other words, a wireless station inside of the region of wireless coverage defined by the distance D2 from the wireless access point 131 is able to receive wireless signals over the wireless channel #10 transmitted from the antenna hardware 131-1. Conversely, a wireless station outside of the region wireless coverage defined by the distance D2 from the wireless access point 131 is not able to receive wireless signals over the wireless channel #10 transmitted from the antenna hardware 131-1.

Assume that the communication management resource 140 selects wireless channel #9 to communicate with one or more mobile communication devices in the network environment 100. In such an instance, the communication management resource 140 applies the power control setting PWR-CH9-1 to the antenna hardware driver circuitry 142. Based on the power control setting PWR-CH9-1 (such as wireless communications transmitted at a power level of 27 dBm), the antenna hardware 131-1 is able to communicate with any communication devices within distance D3 measured from the wireless station. In other words, a wireless station inside of the region of wireless coverage defined by the distance D3 from the wireless access point 131 is able to receive wireless signals over the wireless channel #9 transmitted from the antenna hardware 131-1. Conversely, a wireless station outside of the region wireless coverage defined by the distance D9 from the wireless access point 131 is not able to receive wireless signals over the wireless channel #9 transmitted from the antenna hardware 131-1.

Accordingly, as previously discussed, each of the different power control settings in the wireless power level control information 145-1 supports a different range of wireless communication with respect to the wireless access point 131.

More specifically, as indicated by the power control information 145-1, the power control setting PWR-CH1-1 supports the downlink communications with any communication devices residing in the distance D1 with respect to the wireless access point 131; the power control setting PWR-CH2-1 supports the downlink communications with any communication devices residing in the distance D2 with respect to the wireless access point 131; the power control setting PWR-CH3-1 supports the downlink communications with any communication devices residing in the distance D3 with respect to the wireless access point 131; the power control setting PWR-CH4-1 supports the downlink communications with any communication devices residing in the distance D4 with respect to the wireless access point 131; the power control setting PWR-CH5-1 supports the downlink communications with any communication devices residing in the distance D5 with respect to the wireless access point 131; the power control setting PWR-CH6-1 supports the downlink communications with any communication devices residing in the distance D6 with respect to the wireless access point 131; the power control setting PWR-CH7-1 supports the downlink communications with any communication devices residing in the distance D5 with respect to the wireless access point 131; and so on.

Thus, application of different power level control settings as indicated by the wireless power level control information 145-1 results in different wireless power output levels for each of the multiple wireless channels 1-11.

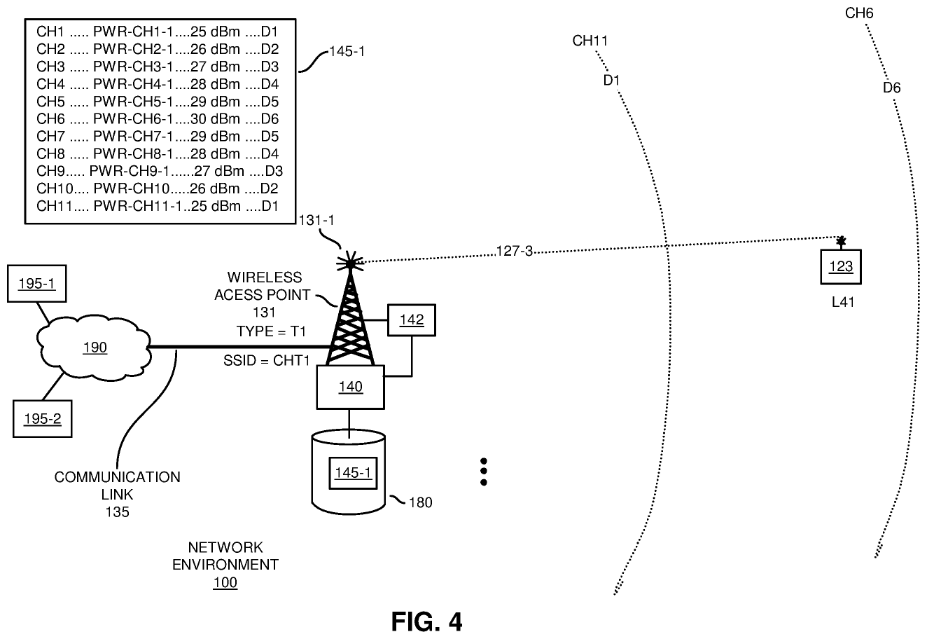

FIG. 4 is an example diagram illustrating how switchover from a first wireless channel to a second wireless channel using the first power level control information results in a corresponding lost connection to a respective mobile communication device as discussed herein.

In this example, the communication management resource 140 implements use of the power level control information 145-1 to provide wireless communications to the mobile communication device 123. The mobile communication device 123 resides at the location L41. Initially, assume that the communication management resource 140 selects wireless channel #6 to communicate wireless messages from the wireless station 131 to the mobile communication device 123. In such an instance, the communication management resource 140 applies the power control settings PWR-CH6-1 to the antenna driver circuitry 142. In such an instance, the mobile communication device 123 at location L41 is able to receive the wireless communications transmitted in a wireless channel #6 over the wireless communication link 127-3 to the mobile communication device 123 because it resides within the respective wireless communication coverage of the wireless access point 131 for wireless channel #6.

Assume that the channel #6 becomes congested and the communication management resource 140 determines that the wireless channel #1 is relatively free from use by other users and experiences low interference. In such an instance, the communication management resource 140 switches over from applying power control settings PWR-CH6-1 to applying power control settings PWR-CH1-1 associated with wireless channel #1. The communication management resource 140 also switches over to transmitting wireless communications over the wireless channel #1 instead of the wireless channel #6.

As previously discussed, implementation of the power control settings PWR-CH1-1 results in a smaller region of wireless coverage provided by the antenna hardware 131-1 associated with the wireless station 131 with respect to a region of wireless coverage provided by use of wireless channel #6. As shown, switchover to wireless channel #1 results in an inability of the wireless communication link 127-3 to convey wireless communications from the antenna hardware 131-1 to the mobile communication device 123 because it is out of range beyond distance D1 with respect to the wireless station 131. Thus, switchover from implementing the wireless channel #6 to wireless channel #1 to communicate with the communication device 123 results in termination of the wireless communication link 127-3.

Note that the wireless access point 131 can be classified as a type T1. In one example, each of multiple wireless access points classified as the type T1 are configured to use the power control information 145-1 to communicate in the respective network environment 100.

As further discussed herein, the power level control information 145-1 can be adjusted to support better switchover from one wireless channel to another.

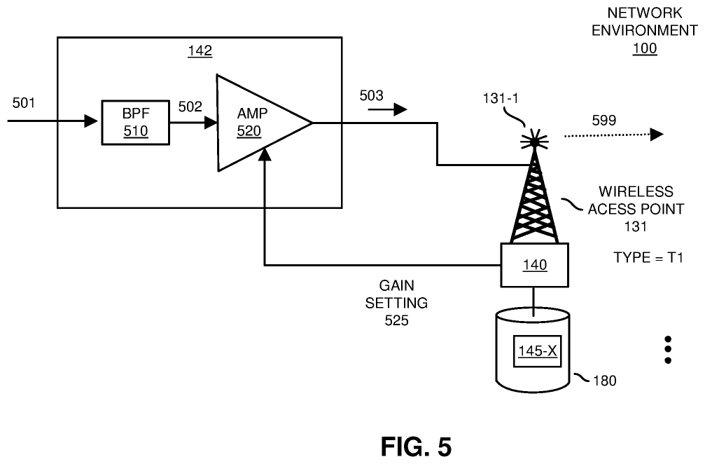

FIG. 5 is an example diagram illustrating implementation of power output control settings associated with the first power level control information as discussed herein.

Note that each of the power control settings in the power level control information 145-1 for each respective wireless channel can be configured to include one or more settings to control the antenna driver circuitry 142.

As further shown in FIG. 5, the antenna driver circuitry 142 can be configured to include any suitable components to convert a respective electrical signal 501 (such as carrying data or data packets) over a physical link or medium into a corresponding wireless signal transmitted from the antenna hardware 131-1 into air. For example, the antenna driver circuitry 142 can be configured to include a respective bandpass filter 510, amplifier 520, etc.

During operation, the bandpass filter 510 receives the corresponding signal 501. As its name suggests, the bandpass filter 510 filters the corresponding received signal 501 to produce the corresponding signal 502. The amplifier 520 receives the signal 502 and, based at least in part on a respective gain setting selected by the communication management resource 140, the amplifier 520 amplifies the received signal 502 to produce the corresponding amplified signal 503. The amplified signal 503 transmitted over a physical media or physical link to the antenna hardware 131-1 drives the corresponding antenna hardware 131-1 because the to produce a respective wireless signal 599 transmitted in air. The antenna hardware 131-1 converts the received signal 503 into a corresponding wireless signal transmitted from the antenna hardware 131-1.

For each of the different wireless channels, note that the gain setting 525 of the amplifier 520 is selected such that the corresponding antenna hardware 131-1 outputs corresponding wireless signals 599 at a wireless output power level as specified in the power level control information 145-1.

In one example, the gain setting 525 of the respective amplifier 520 is controlled via the power control settings in the power level control information 145-1. For example, for wireless channel #1, the first power control setting PWR-CH1-1 can be configured to include or specify a gain value (setting) to apply to the amplifier 520 such that the antenna hardware 131-1 transmits wireless signals 599 at the power level of 25 dBm.

For wireless channel #2, the second power control setting PWR-CH2-1 can be configured to include or specify a gain value (setting) to apply to the amplifier 520 such that the antenna hardware 131-1 transmits wireless signals 599 at the power level of 26 dBm.

For wireless channel #3, the third power control setting PWR-CH3-1 can be configured to specify a gain value to apply to the amplifier 520 such that the antenna hardware 131-1 transmits wireless signals 599 at the power level of 27 dBm.

For wireless channel #4, the fourth power control setting PWR-CH4-1 can be configured to specify a gain value to apply to the amplifier 520 such that the antenna hardware 131-1 transmits wireless signals at the power level of 28 dBm.

For wireless channel #5, the fifth power control setting PWR-CH5-1 can be configured to specify a gain value to apply to the amplifier 520 such that the antenna hardware 131-1 transmits wireless signals at the power level of 29 dBm.

For wireless channel #6, the sixth power control setting PWR-CH6-1 can be configured to specify a gain value to apply to the amplifier 520 such that the antenna hardware 131-1 transmits a corresponding wireless signal at the power level of 30 dBm.

In this manner, depending on which of the multiple wireless channels is selected for conveyance of corresponding data over the wireless communication link to a mobile communication device, the communication management resource 140 selects different power control settings and a respective gain settings 525 to control operation of the respective antenna hardware 131-1.

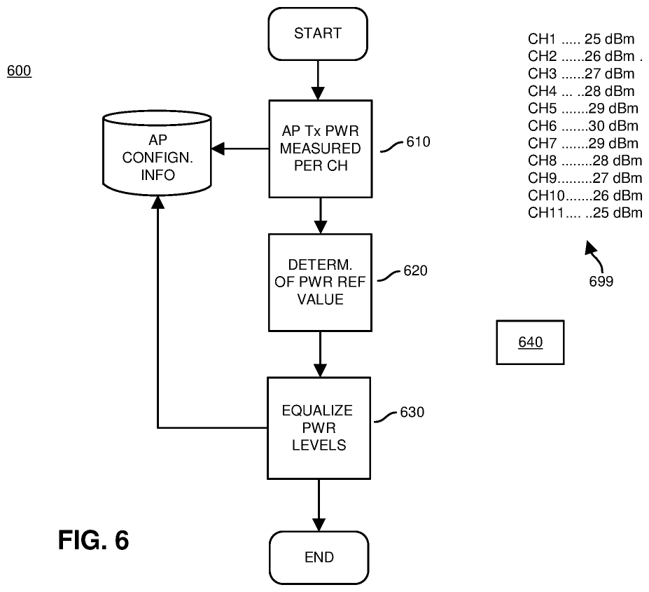

FIG. 6 is an example diagram illustrating a technique (flowchart) of analyzing wireless power output of a respective wireless station implementing the first power level control information to determine a reference wireless power output level of the wireless station amongst multiple different wireless channels as discussed herein.

In one example, the system as described herein includes the communication management resource 640. In general, the communication management resource 640 can be configured to analyze the power control settings associated with the power control information 145-1 as shown a flowchart 600. This can include selecting a reference wireless power output level as a baseline in which to transmit communications from the antenna hardware 131-1 of the wireless access point 131 over each of the multiple wireless channels.

For example, the communication management resource 640 uses the selected reference wireless output power transmit level as a basis in which to produce power control information 145-2, which serves as a replacement to the power control information 145-1. In other words, the communication management resource 640 can be configured to derive the power control information 145-2 and corresponding power control settings based at least in part on the power control information 145-1.

More specifically, in processing operation 610, using power control information 145-1, the communication management resource 640 can be configured to test different wireless power level control settings for each respective wireless channel of the multiple wireless channels to determine a corresponding wireless power level control setting for the respective wireless channel. From the testing, the communication management resource 640 can be configured to determine which of the power control settings in the power control information 145-1 provides the lowest power output level amongst all of the channels. The communication management resource 640 selects that lowest power level as the reference power level. The communication management resource 640 then produces power control information 145-2 and corresponding power control settings for each of the different wireless channels. The power control information 145-2 (such as a substitute to the power control information 145-1) supports a substantially similar wireless power output for each of the selectable wireless channels #1 through #11.

Note that the generated power control information 145-2 can be applied to any other wireless access points of type T1. For example, the network environment 100 may include multiple wireless access points of type T1. For each of those wireless access points assigned the type T1, the communication management resource 640 or other suitable entity can be configured to replace the initially assigned power control information 145-1 with the power control information 145-2.

As a more specific example of deriving the power control information 145-2, in processing operation 610, the communication management resource 640 operates the wireless access point 131 to transmit corresponding wireless signals for each of the wireless channels as specified in the power control information 145-1. The communication management resource 640 measures (or estimates using calculations and/or equations) the wireless power output level for each of the selected power control settings as specified by the power control information 145-1.

More specifically, the communication management resource 640 operates the wireless access point 131 to transmit wireless signals from the antenna hardware 131-1 over the wireless channel #1 via application of the power control setting PWR-CH1-1 to the antenna driver circuitry 142. The communication management resource 640 measures the corresponding wireless transmit power (such as a parameter of total radiated power output or TRP) of wireless signals from the antenna hardware 131-1 and records this detected power level information. In this example, assume that the communication management resource 640 measures the wireless power output of the antenna hardware 131-1 transmitting wireless signals over the wireless channel #1 as being 25 dBm.

For the next channel (such as wireless channel #2), the communication management resource 640 operates the wireless access point 131 to transmit wireless signals from the antenna hardware 131-1 over the wireless channel #2 via application of the power control setting PWR-CH2-1 to the antenna driver circuitry 142. The communication management resource 640 measures the corresponding wireless transmit power (such as a parameter of total radiated power output or TRP) of wireless signals from the antenna hardware 131-1 and records this detected power level information. In this example, assume that the communication management resource 640 measures the wireless power output of the antenna hardware 131-1 transmitting wireless signals over the wireless channel #2 as being 26 dBm.

For the next channel (such as wireless channel #3), the communication management resource 640 operates the wireless access point 131 to transmit wireless signals from the antenna hardware 131-1 over the wireless channel #3 via application of the power control setting PWR-CH3-1 to the antenna driver circuitry 142. The communication management resource 640 measures the corresponding wireless transmit power (such as a parameter of total radiated power output or TRP) of wireless signals from the antenna hardware 131-1 and records this detected power level information. In this example, assume that the communication management resource 640 measures the wireless power output of the antenna hardware 131-1 transmitting wireless signals over the wireless channel #3 as being 27 dBm.

The communication management resource 640 repeats this process of operating the wireless access point 131 at each of the different wireless channels using the different power control settings as specified by the power control information 145-1. As shown in FIG. 6, the communication management resource 640 produces the power information 699, which indicates a respective wireless power output level (or total radiated power) associated with each of the different wireless channels and corresponding power control settings as specified by the power control information 145-1.

Thus, to gather a baseline of transmit power, a Total Radiated Power (TRP) measurement may be taken on each channel of interest. TRP is a measure of how much power is radiated by the antenna hardware 131-1 and the wireless access point 131. After the TRP measurements are gathered per channel, and recorded in the power information 699, the communication management resource 640 executes the processing operation 620. In processing operation 620, the communication management resource 640 or other suitable entity can be configured to determine a reference power level from the power information 699. In one example, the reference power level is chosen as the minimal power output value as recorded in the power information 699.

As a more specific example, in processing operation 620, the communication management resource 640 determines that the lowest power output level associated with the power control information 145-1 corresponds to wireless channel #1 and wireless channel #11 settings.

In processing operation 630, the communication management resource 640 or other suitable entity generates the corresponding power control information 145-2 such that the corresponding power control settings produce a substantially same wireless power output level for each of the different wireless channel #1 through wireless channel #11. In one example, generation of the power control information 145-2 is achieved via reducing wireless power output levels for wireless channels #2 through wireless channel #10 to the level associated with the wireless channel #1 and #11. The reduction in the power tables as captured by the power control information 145-2 ensures there is balanced AP (i.e., wireless access point 131) transmit power.

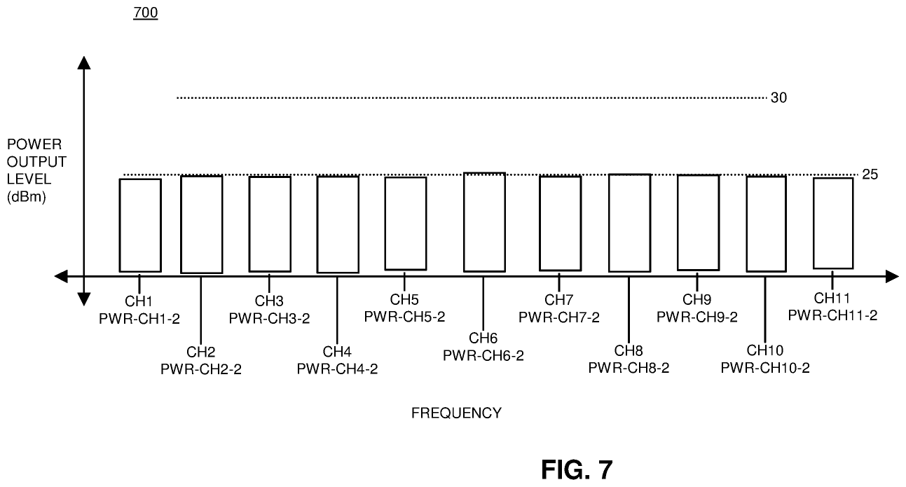

FIG. 7 is an example graph illustrating different wireless output power levels provided by implementation of second power level control information is discussed herein.

As shown in graph 700 a FIG. 7, implementation of the power control settings 145-to for each of the wireless channels #1 through #11 results in a substantially equal power output of the antenna hardware 131-1 associated with wireless station 131. In other words, implementation of the power control information 145-2 results in the antenna hardware 131-1 transmitting wireless signals at substantially the same wireless power level of around 25 dBm. In such an instance, the region of wireless coverage provided by the wireless access point 131 and corresponding antenna hardware 131-1 is substantially equal for the different wireless channels. Accordingly, there is no issue associated with handing off a respective mobile communication device from using a first wireless channel #6 to using a second wireless channel #1 because both wireless channels support the same range with respect to the wireless access point 131.

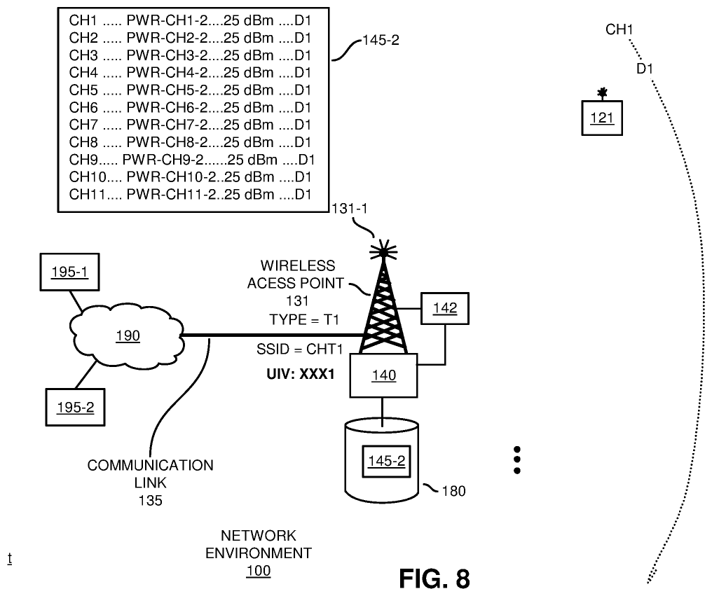

Subsequent to generating the power control information 145-2, the communication management resource 640 or other suitable entity initiates replacement of the power control information 145-1 with the power control information 145-2 for the wireless access point 131 and any other wireless access point of type T1. An example of using the power control information 145-to a corresponding power control settings for each of the wireless channels is shown in FIG. 8.

Thus, techniques herein include determining wireless power level control settings (such as power control setting to PWR-CH1-2, PWR-CH2-2, PWR-CH3-2, PWR-CH4-2, PWR-CH5-2, . . . , PWR-CH10-2, PWR-CH11-2) to provide substantially equal wireless power output from antenna hardware of a wireless station for each of multiple wireless channels. Via the determined wireless power level control settings PWR-CH1-2, PWR-CH2-2, PWR-CH3-2, PWR-CH4-2, PWR-CH5-2, . . . , PWR-CH10-2, and PWR-CH11-2, the communication management resource 640 or other suitable entity produces the wireless power level control information 145-2 to control the wireless access point 131 according to a respective selected baseline reference power level such as 25 dBm or other suitable value.

The wireless power level control information 145-2 is updated wireless power level control information with respect to first wireless power level control information 145-1 initially associated with the wireless access point 131.

As previously discussed, the communication management resource 640 or other suitable entity configures the wireless access point 131 with the wireless power level control information 145-2 as a replacement to the wireless power level control information 145-1. The determined wireless power level control settings as specified by the power control information 145-2 indicate different settings to apply to corresponding antenna hardware driver circuitry 142 of the wireless access point 131 and corresponding antenna hardware 131-1.

FIG. 8 is an example diagram illustrating implementation of alternative power control settings to provide communication devices wireless connectivity to a remote network as discussed herein.

In this example, the communication management resource 140 applies the updated power control information 145-2 (as a replacement to power control information 145-1) and corresponding power control settings to control a respective wireless power output of the antenna hardware 131-1 of the wireless access point 131.

For example, to communicate with the mobile communication device 121 in FIG. 8, the communication management resource 140 initially selects the wireless channel #6 to support communications with the mobile communication device 121. In such an instance, the communication management resource 140 applies the power control settings PWR-CH6-2 associated with the wireless channel #6 to the antenna driver circuitry 142. This causes the antenna hardware 131-1 to transmit a respective wireless communications over wireless channel #6 at a power level of 25 dBm (such as the selected wireless output reference level). Transmission of the wireless communications over the wireless channel #6 at the wireless power level of 25 dBm results in the ability of the wireless access point 131 to communicate with any mobile communication devices within the distance D1 from the wireless access point 131.

Assume that the communication management resource 140 detects a high amount of interference in the wireless channel #6. This causes the communication management resource 140 to choose wireless channel #1 as an alternative to wireless channel #6 to support wireless communications with the mobile communication device 121. In such an instance, the communication management resource 140 applies the power control settings PWR-CH1-2 associated with the wireless channel #6 to the antenna driver circuitry 400 142. This causes the antenna hardware 131-1 to transmit a respective wireless communications over the wireless channel #1 at a power level of 25 dBm. Transmission of the wireless communications over the wireless channel #1 at the wireless power level of 25 dBm results in the ability of the wireless access point 131 to communicate with any mobile communications devices within the distance D1 from the wireless access point 131.

Thus, via the power control information 145-2, regardless of the selected wireless channel, the antenna hardware 131-1 produces a substantially same wireless power output for each of the different wireless channels 1 through 11. This alleviates the issue of dropping a respective wireless communication link as discussed in FIG. 4.

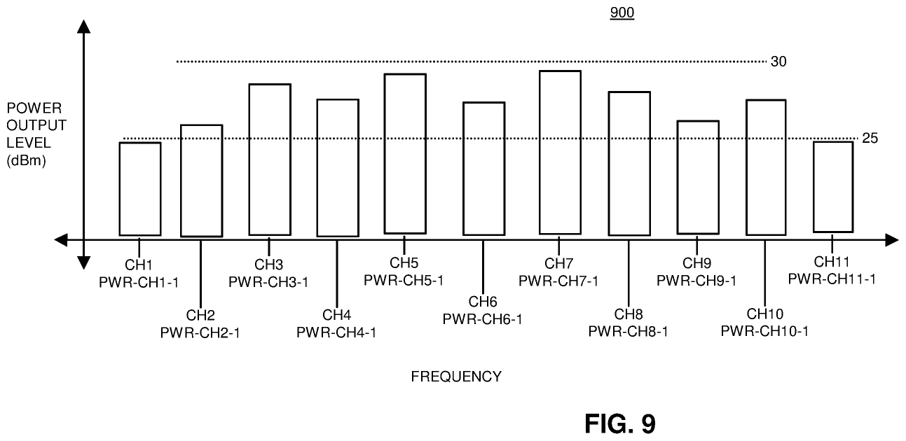

FIG. 9 is an example diagram illustrating generation of a third power level control information providing substantially equal wireless power output for each of multiple wireless channels as discussed herein.

In this example, the wireless output power level associated with the different wireless channels may vary between wireless channel #1 and wireless channel #11 based on the power control information 145-1. Note that it is not necessary for the communication management resource 640 to choose the lowest power output level as a basis in which to equalize power outputs across the different wireless channels. In this example, the communication management resource 640 or other suitable entity selects any suitable reference value as a basis in which to equalize wireless power output across the different wireless channels to produce the corresponding power control information 145-2 providing power output as indicated by FIG. 2 instead of FIG. 9.

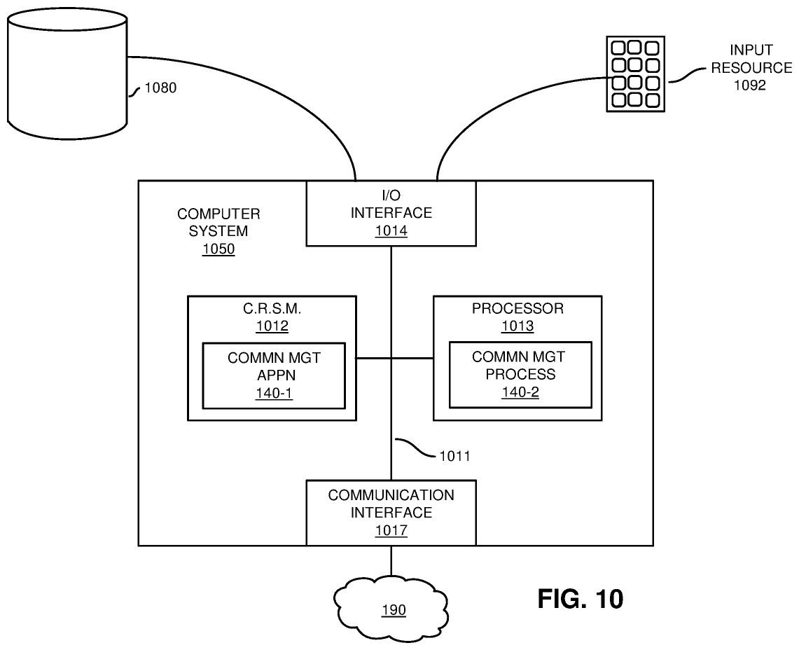

FIG. 10 is an example diagram illustrating example computer architecture operable to execute one or more operations according to examples herein.

Note that any of the resources (such as communication management resource 140, wireless access point 131, communication management resource 640, mobile communication device 121, mobile communication device 122, mobile communication device 123, etc.) as discussed herein can be configured to include computer processor hardware and/or corresponding executable instructions to carry out the different operations as discussed herein.

As shown, computer system 1050 of the present example includes an interconnect 1011 that couples computer readable storage media 1012 such as a non-transitory type of media (which can be any suitable type of hardware storage medium in which digital information can be stored and retrieved), a processor 1013 (computer processor hardware), I/O interface 1014, and a communications interface 1017.

I/O interface(s) 1014 supports connectivity to repository 1080 and input resource 1092.

Computer readable storage medium 1012 can be any hardware storage device such as memory, optical storage, hard drive, floppy disk, etc. In one example, the computer readable storage medium 1012 stores instructions and/or data.

As shown, computer readable storage media 1012 can be encoded with communication management application 140-1 (e.g., including instructions) to carry out any of the operations as discussed herein associated with communication management resource 140, communication management resource 640, etc.

During operation of one example, processor 1013 accesses computer readable storage media 1012 via the use of interconnect 1011 in order to launch, run, execute, interpret or otherwise perform the instructions associated with the communication management application 140-1 stored on computer readable storage medium 1012 (also known as computer readable storage hardware). Execution of the communication management application 140-1 produces communication management process 140-2 to carry out any of the operations and/or processes as discussed herein.

Those skilled in the art will understand that the computer system 1050 can include other processes and/or software and hardware components, such as an operating system that controls allocation and use of hardware resources to execute communication management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein.

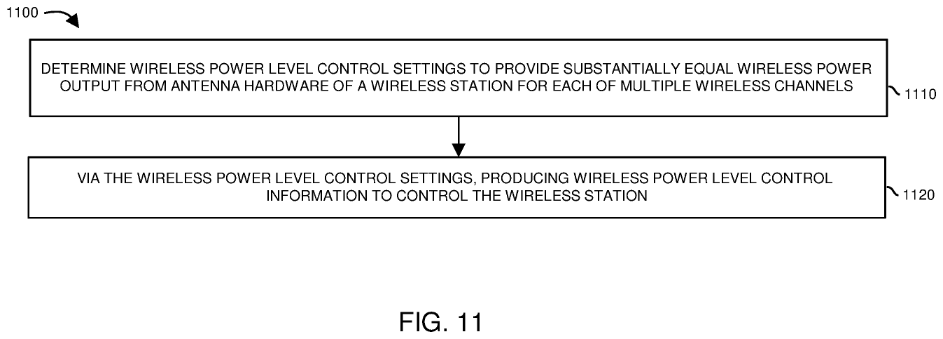

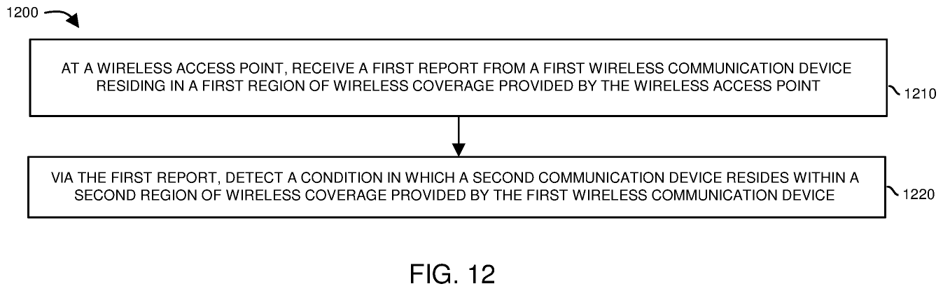

Functionality supported by the different resources will now be discussed via flowcharts in FIGS. 11 and 12. Note that the steps in the flowcharts below can be executed in any suitable order.

FIG. 11 is a flowchart 1100 illustrating an example method according to examples. Note that there will be some overlap with respect to concepts as discussed above.

In processing operation 1110, the communication management resource 140 or communication management resource 640 determines wireless power level control settings to provide substantially equal wireless power output from antenna hardware 121 wireless station 131 for each of multiple wireless channels (such as wireless channel #1, wireless channel #2, wireless channel #3, . . . , wireless channel #11).

In processing operation 1120, via the determined wireless power level control settings (that produce substantially equal wireless power output over each of the wireless channels), the communication management resource 140 or communication management resource 640 produces corresponding wireless power level control information 145-2 to subsequently control the wireless station 131.

FIG. 12 is a flowchart 1200 illustrating an example method according to examples. Note that there will be some overlap with respect to concepts as discussed above.

In processing operation 1210, the communication management resource 140 receives first power level control information 145-1 to control operation of a wireless station (wireless access point 131). The first power level control information includes first control settings to control wireless power output levels of the wireless station for multiple wireless channels #1, #2, #3, . . . , #11.

In processing operation 1220, the communication management resource 140 produces second power level control information 145-2 as a replacement to the first power level control information 145-1. The second power level control information 145-to includes second control settings. Application of the second power control settings to the wireless access point 131 results in substantial equalization (such as a selected wireless power output reference) of the wireless power output levels of the wireless station over each of the multiple wireless channels.

Note again that techniques herein are well suited to facilitate testing and dynamic control of transmit power levels of one or more wireless access points to reduce interference amongst each other and to provide better switchover from one wireless channel to another. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
determining wireless power control settings to provide substantially equal wireless power output from antenna hardware of a wireless station for each of multiple wireless channels; and
via the wireless power control settings, producing wireless power control information to control the wireless station.

2. The method as in claim 1, further comprising
configuring the wireless station with the wireless power control information.

3. The method as in claim 1, wherein the wireless power control information is updated wireless power control information with respect to first wireless power control information initially associated with the wireless station.

4. The method as in claim 3 further comprising:
analyzing corresponding wireless output power levels associated with the wireless station transmitting wireless signals via different settings of the first wireless power control information to determine a particular wireless channel amongst the multiple wireless channels that provides a lowest wireless output power from the antenna hardware of the wireless station.

5. The method as in claim 4, wherein producing wireless power control information includes:
selecting a first wireless power control setting for a first wireless channel of the multiple wireless channels, application of the first wireless power control setting to the antenna hardware of the wireless station producing a first wireless output power from the antenna hardware, the first wireless output power being substantially equal to the lowest wireless output power level; and
selecting a second wireless power control setting for a second wireless channel of the multiple wireless channels, application of the second wireless power control setting to the antenna hardware of the wireless station producing a second wireless output power from the antenna hardware, the second wireless output power being substantially equal to the lowest wireless output power level.

6. The method as in claim 1, wherein the determined wireless power control settings indicate different settings to apply to corresponding antenna hardware driver circuitry of the wireless station, the corresponding antenna hardware driver circuitry controlling transmission of communications from the antenna hardware of the wireless station.

7. The method as in claim 1, wherein determining the wireless power control settings includes:
selecting a reference wireless power output level.

8. The method as in claim 7, wherein determining the wireless power control settings further includes:
deriving the wireless power control settings based on the reference wireless power output level.

9. The method as in claim 7, wherein selecting the wireless power control settings further includes:
testing different wireless power control settings for each respective wireless channel of the multiple wireless channels to determine a corresponding wireless power control setting for the respective wireless channel, application of the corresponding wireless power control setting producing a wireless power output of the antenna hardware of the wireless station to be substantially equal to the reference wireless power output level for the respective wireless channel.

10. The method as in claim 1, wherein the wireless power control information is second wireless power control information with respect to first wireless power control information associated with the wireless station, application of different wireless power control settings to the wireless station as indicated by the first wireless power control information resulting in different wireless power output levels for each of the multiple wireless channels.

11. A system comprising:
processing hardware operative to:
determine wireless power control settings to provide substantially equal wireless power output from antenna hardware of a wireless station for each of multiple wireless channels; and
via the wireless power control settings, produce wireless power control information to control the wireless station.

12. The system as in claim 11, wherein the processing hardware is further operative to:
configure the wireless station with the wireless power control information.

13. The system as in claim 11, wherein the wireless power control information is updated wireless power control information with respect to first wireless power control information initially associated with the wireless station.

14. The system as in claim 13, wherein the processing hardware is further operative to:
analyze corresponding wireless output power levels associated with the wireless station transmitting wireless signals via different settings of the first wireless power control information to determine a particular wireless channel amongst the multiple wireless channels that provides a lowest wireless output power from the antenna hardware of the wireless station.

15. The system as in claim 14, wherein the processing hardware is further operative to:
select a first wireless power control setting for a first wireless channel of the multiple wireless channels, application of the first wireless power control setting to the antenna hardware of the wireless station producing a first wireless output power from the antenna hardware, the first wireless output power being substantially equal to the lowest wireless output power level; and
select a second wireless power control setting for a second wireless channel of the multiple wireless channels, application of the second wireless power control setting to the antenna hardware of the wireless station producing a second wireless output power from the antenna hardware, the second wireless output power being substantially equal to the lowest wireless output power level.

16. The system as in claim 11, wherein the determined wireless power control settings indicate different settings to apply to corresponding antenna hardware driver circuitry of the wireless station, the corresponding antenna hardware driver circuitry controlling transmission of communications from the antenna hardware of the wireless station.

17. The system as in claim 11, wherein the processing hardware is further operative to:
select a reference wireless power output level.

18. The system as in claim 17, wherein the processing hardware is further operative to:
derive the wireless power control settings based on the reference wireless power output level.

19. The system as in claim 17, wherein the processing hardware is further operative to:
test different wireless power control settings for each respective wireless channel of the multiple wireless channels to determine a corresponding wireless power control setting for the respective wireless channel, application of the corresponding wireless power control setting producing a wireless power output of the antenna hardware of the wireless station to be substantially equal to the reference wireless power output for the respective wireless channel.

20. The system as in claim 11, wherein the wireless power control information is second wireless power control information with respect to first wireless power control information associated with the wireless station, application of different wireless power control settings to the wireless station as indicated by the first wireless power control information resulting in different wireless power output levels for each of the multiple wireless channels.

21. A method comprising:
receiving first power control information to control operation of a wireless station, the first power control information including first control settings to control wireless power output levels of the wireless station for multiple wireless channels; and
producing second power control information as a replacement to the first power control information, the second power control information including second control settings, application of the second control settings operable to substantially equalize wireless power output levels of the wireless station over each of the multiple wireless channels.

22. The method as in claim 21 further comprising
configuring the wireless station with the second power control information as the replacement to the first power control information.

23. The method as in claim 21, wherein the second control settings indicate different settings to apply to corresponding antenna hardware driver circuitry of the wireless station, the corresponding antenna hardware driver circuitry controlling transmission of communications from antenna hardware of the wireless station.

24. The method as in claim 21, wherein producing the second power control information includes:
determining a first wireless output of the wireless station for a first wireless channel of the multiple wireless channels based on a first setting of the first control settings;
selecting the first wireless output as a basis in which to control the wireless output of the wireless station for the second control settings.

25. Computer-readable storage hardware having instructions stored thereon, the instructions, when carried out by computer processor hardware, cause the computer processor hardware to:
receive first power control information to control operation of a wireless station, the first power control information including first control settings to control wireless power output levels of the wireless station for multiple wireless channels; and
produce second power control information as a replacement to the first power control information, the second power control information including second control settings, application of the second control settings operable to substantially equalize wireless power output levels of the wireless station over each of the multiple wireless channels.
